(19) United States
(12) Patent Application Publication
(10) Pub. No.: US 2013/0271858 A1
(43) Pub. Date: Oct. 17, 2013

(54) LENS STRUCTURE AND IMAGE CAPTURING DEVICE THEREOF

(71) Applicants: Hong-Bin KOH, New Taipei City (TW); Chyi-Fa Lin, New Taipei City (TW)

(72) Inventors: Hong-Bin KOH, New Taipei City (TW); Chyi-Fa Lin, New Taipei City (TW)

(21) Appl. No.: 13/482,443

(22) Filed: May 29, 2012

(30) Foreign Application Priority Data
Apr. 12, 2012 (TW) 101113090

(51) Int. Cl. G02B 7/02

(52) U.S. Cl. 359/819

(57) ABSTRACT

The invention is directed to a lens structure and an image capturing device thereof including a lens barrel being a barrel-like shape structure and having an inner wall not parallel with a central axis, and a lens having an engaging side apart from an optical axis, wherein the engaging side corresponds to the inner wall, such that the engaging side of the lens is engaged with the inner wall and in the lens barrel.

### CROSS-REFERENCE TO RELATED APPLICATION

This application claims the benefit of Taiwan Patent Application No. 101113090, filed on Apr. 12, 2012, in the Taiwan Intellectual Property Office, the disclosure of which is incorporated herein in its entirety by reference.

### BACKGROUND OF THE DISCLOSURE

1. Field of the Disclosure

The present invention relates to a lens structure, and more particularly, to a lens structure and an image capturing device thereof having a surface for engaging an inner wall of a lens barrel and a side of a lens, wherein the surface is not parallel with an optical axis of the image capturing device.

2. Brief Description of the Related Art

With development of an optical imaging technology, a lens module can be widely employed in various imaging devices, such as digital camera, image capturing device or mobile phone. Mobile electronic device integrated with the lens module, such as a DSC, a smart phone, is much favored by customers.

Typically, a set of lenses mounted in a lens barrel are necessary to be precisely positioned for good performance. Currently, the lens module includes a lens barrel and several optical elements, such as lenses, which are arranged and fixed in the lens barrel by dispensing.

However, the lens module has diminished stability in case of weak joints of dispensing the optical elements or matured glue, such that when the lens module is shook, the optical elements in the lens module may displace along an optical axis thereof. Thus, the conventional lens module has an unstable inner structure.

Furthermore, when a surface for engaging an inner wall of a lens barrel and sides of lenses is designed parallel with an optical axis, a size error would exist at the engagement between the sides of the lenses and the inner wall of the lens barrel. Accordingly, when the lenses are engaged with the inner wall of the lens barrel, the lenses becoming loose or squeezed would happen.

In the prior art, a method for engaging the set of lenses in the lens barrel is performed by engaging a first lens on the inner wall of the lens barrel, next engaging a second lens on the inner wall of the first lens, and next engaging a third lens on the second lens. When the first lens become loose due to wear between the side of the first lens and the inner wall of the lens barrel, this leads the second and third lenses to become loose and leads these lenses to be out of center. Accordingly, resolution is caused to be reduced.

Besides, the set of lenses are stacked each other, and thus the lens structure is quite complicated. Accordingly, the lenses can only be made of plastic and cannot be made of glass. If the lenses are made of glass, these lenses would be led to be out of center.

### SUMMARY OF THE DISCLOSURE

In order to improve the above-mentioned problems of prior art, the present invention is directed to a lens structure and an image capturing device thereof having a surface for engaging an inner wall of a lens barrel and a side of a lens, wherein the surface is not parallel with an optical axis. This arrangement can improve the traditional problem of the error at the engagement between the sides of the lenses and the inner wall of the lens barrel when a contact surface between a side of a lens and an inner wall of a lens barrel is designed parallel with an optical axis, and also can improve the traditional problem that resolution is reduced due to the lenses being loose and out of center. This result from the wear created on the inner wall of the lens barrel when the sides of the lenses in the set of lenses are engaged on the inner wall of the lens barrel.

In accordance with an objective of the present invention, a lens structure is proposed including a lens barrel being a barrel-like shape structure and having an inner wall not parallel with a central axis, and a lens having an engaging side apart from an optical axis, wherein the engaging side corresponds to the inner wall, and the engaging side of the lens is engaged with the inner wall and in the lens barrel.

In an embodiment, the lens has a shift along the optical axis when the inner wall is worn, and the engaging side is engaged with the inner wall again due to the shift.

In an embodiment, an angle between the inner wall and a radial direction of the lens barrel and an angle between the engaging side and the radial direction are between 45 and 80 degrees.

In an embodiment, the inner wall has a first engaging surface and a second engaging surface, and an angle between the first engaging surface and the radial direction of the lens barrel is different from that between the second engaging surface and the radial direction of the lens barrel.

In accordance with an objective of the present invention, a lens structure is proposed including a lens barrel being a barrel-like shape structure and having an inner wall not parallel with a central axis, a first lens having a first engaging side apart from an optical axis, wherein the first engaging side corresponds to the inner wall, and the first engaging side of the first lens is engaged with the inner wall and in the lens barrel, and a second lens having a second engaging side apart from the optical axis, wherein the second engaging side corresponds to the inner wall, and the second engaging side of the second lens is engaged with the inner wall and in the lens barrel.

In an embodiment, the first or second lens has a shift along the optical axis when the inner wall is worn, and the first or second engaging side is engaged with the inner wall again due to the shift.

In an embodiment, an angle between the inner wall and a radial direction of the lens barrel, an angle between the first engaging side and the radial direction and an angle between the second engaging side and the radial direction are between 45 and 80 degrees.

In an embodiment, the inner wall has a first engaging surface and a second engaging surface, and an angle between the first engaging surface and the radial direction of the lens barrel is different from that between the second engaging surface and the radial direction of the lens barrel, and the first engaging side is engaged with the first engaging surface, and the second engaging side is engaged with the second engaging surface.

In accordance with an objective of the present invention, an image capturing device is proposed including a lens structure and a lens pedestal, wherein the lens structure includes a lens barrel being a barrel-like shape structure and having an inner wall not parallel with a central axis, a first lens having a first engaging side apart from an optical axis, wherein the first engaging side corresponds to the inner wall, and the first engaging side of the first lens is engaged with the inner wall and in the lens barrel, and a second lens having a second engaging side apart from the optical axis, wherein the second engaging side corresponds to the inner wall, and the second engaging side of the second lens is engaged with the inner wall and in the lens barrel.

In an embodiment, when the first or second lens has a shift along the optical axis when the inner wall is worn, and the first or second engaging side is engaged with the inner wall again due to the shift.

In an embodiment, an angle between the inner wall and a radial direction of the lens barrel, an angle between the first engaging side and the radial direction and an angle between the second engaging side and the radial direction are between 45 and 80 degrees.

In an embodiment, the inner wall has a first engaging surface and a second engaging surface, wherein an angle between the first engaging surface and the radial direction of the lens barrel is different from that between the second engaging surface and the radial direction of the lens barrel, wherein the first engaging side is engaged with the first engaging surface, and the second engaging side is engaged with the second engaging surface.

Accordingly, in accordance with the present invention, the lens structure and the image capturing device thereof have following advantages:

(1) The lens structure and the image capturing device thereof are designed with the inner wall of the lens barrel and the sides of the lenses, and thus the errors in assembly can be dramatically reduced.

(2) The lens structure and the image capturing device thereof are designed with the inner wall of the lens barrel and the sides of the lenses, and thus the problem that the lenses become loose and out of center can be avoided when the inner wall of the lens barrel wears.

(3) The lens structure and the image capturing device thereof are designed with the inner wall of the lens barrel and the sides of the lenses, and the problem that the lenses become out of center can be avoided when the lenses are made of glass.

(4) The lens structure and the image capturing device thereof are designed with the inner wall of the lens barrel and the sides of the lenses, and thus a squeeze between the inner wall of the lens barrel and the sides of the lenses can be avoided when the lenses are engaged with the lens barrel.

(5) The lens structure and the image capturing device thereof are designed with the inner wall of the lens barrel and the sides of the lenses, and thus the traditional problem that the set of the lenses engaged with the lens barrel is loose and led to be out of center can be avoided.

### BRIEF DESCRIPTION OF THE DRAWINGS

FIG. 1 is a first schematic view of a lens structure in accordance with a first embodiment of the present invention.

FIG. 2 is a second schematic view of a lens structure in accordance with a first embodiment of the present invention.

FIG. 3 is a third schematic view of a lens structure in accordance with a first embodiment of the present invention.

FIG. 4 is a first schematic view of a lens structure in accordance with a second embodiment of the present invention.

FIG. 5 is a second schematic view of a lens structure in accordance with a second embodiment of the present invention.

FIG. 6 is a third schematic view of a lens structure in accordance with a second embodiment of the present invention.

FIG. 7 is a schematic view of a lens of a lens structure in accordance with the present invention.

FIG. 8 is a schematic view of an image capturing device in accordance with the present invention.

### DETAILED DESCRIPTION OF THE INVENTION

Following illustration accompanying with figures is embodiments for describing a lens structure and an image capturing device thereof. In the following embodiments, same elements are indicated by same reference numbers.

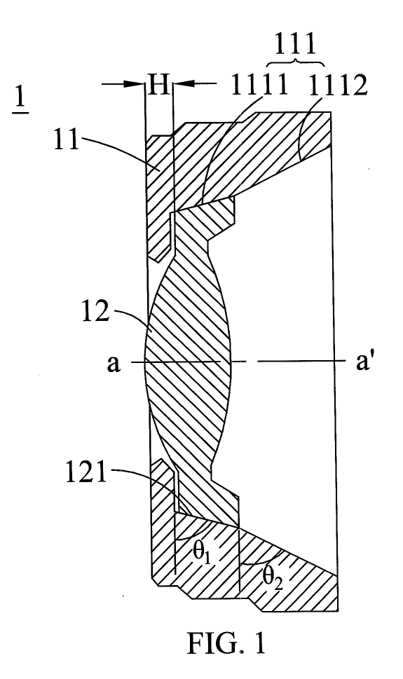

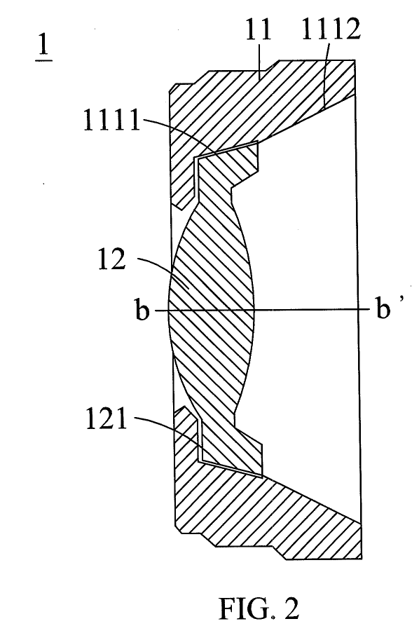

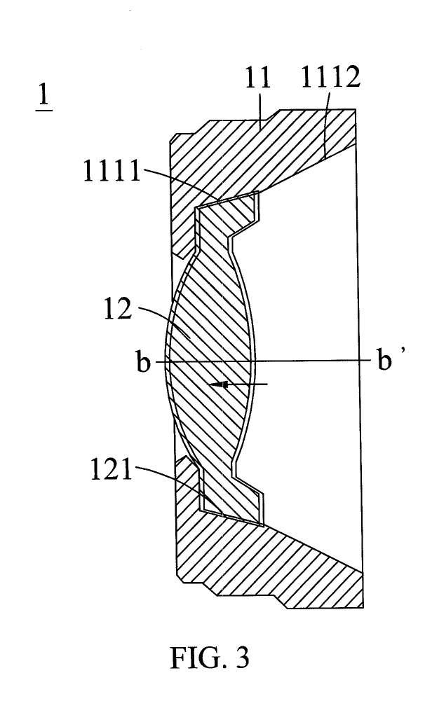

FIGS. 1 to 3 are first to three schematic views of a lens structure in accordance with a first embodiment of the present invention. Referring to FIGS. 1 to 3, a lens structure 1 includes a lens barrel 11 shaped like a barrel and having an inner wall 111 not parallel with a central axis aa′, and a lens 12 having an engaging side 121 apart from an optical axis bb′, wherein the engaging side 121 corresponds to the inner wall 111, such that the engaging side 121 of the lens 12 is engaged with the inner wall 111 and in the lens barrel 11.

In an embodiment, when the inner wall 111, due to wearing, is separate from the engaging side 121, the lens 12 has a shift along the optical axis bb′ such that the engaging side 121 is engaged with the inner wall 111 again.

In an embodiment, an angle between the inner wall 111 and a radial direction of the lens barrel 11 and an angle between the engaging side 121 and the radial direction are between 45 and 80 degrees.

In an embodiment, the inner wall 111 has a first engaging surface 1111 and a second engaging surface 1112, wherein an angle θ₁ between the first engaging surface 1111 and the radial direction of the lens barrel 11 is different from an angle θ₂ between the second engaging surface 1112 and the radial direction of the lens barrel 11.

In the present embodiment, the engaging side 121 is engaged with the first engaging surface 1111. Alternatively, the engaging side 121 can be engaged with the second engaging surface 1112.

For example, in accordance with the present invention, the lens structure 1 is designed with the lens barrel 11 having the inner wall 111 not parallel with the central axis aa′ such that the engaging side 121 of the lens 12 corresponding to the first engaging surface 1111 can be engaged with the first engaging surface 1111. Both an angle between the first engaging surface 1111 and the radial direction of the lens barrel 11 and an angle between the engaging side 121 and the radial direction of the lens barrel 11 can be the same angle θ₁ ranging from 45 to 80 degrees.

When the engaging side 121 is engaged with the first engaging surface 1111, a distance H between a surface of the lens 12 and an end of the lens barrel 11 can be changed to absorb the errors created in the prior art. Accordingly, loose, squeeze or interference between the sides 121 of the lenses 12 and the first engaging surface 1111 of the lens barrel 11 can be avoided.

Besides, when the first engaging surface 1111 engaged with the engaging side 121 wears, the lens barrel 11 has an enlarged inner diameter and thus the first engaging surface 1111 is separate from the engaging side 121. At this time, the lens 12 can move to an end of the optical axis bb′ such that the engaging side 121 is engaged with the first engaging surface 1111 again. The problem that the lens 12 is loose or out of center can be avoided.

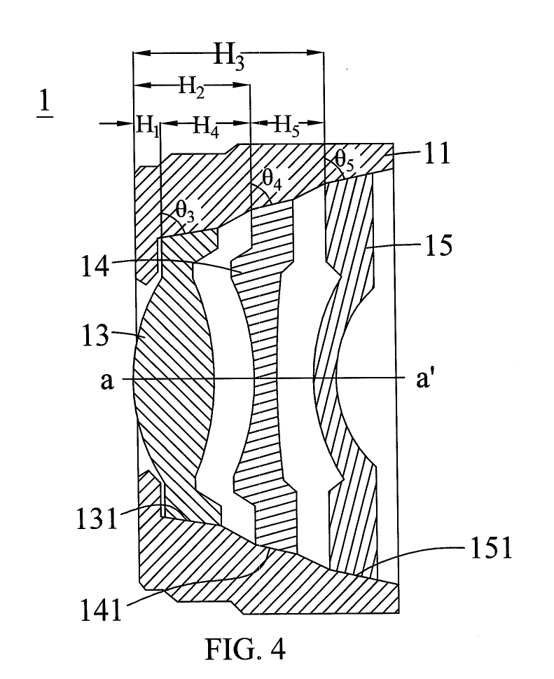

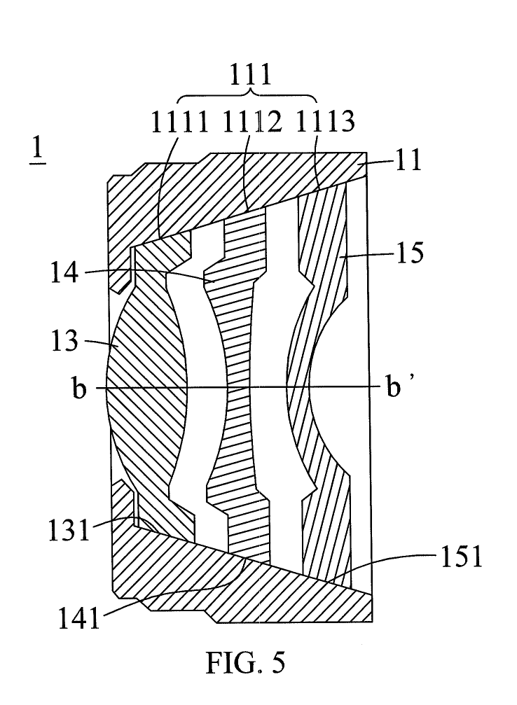

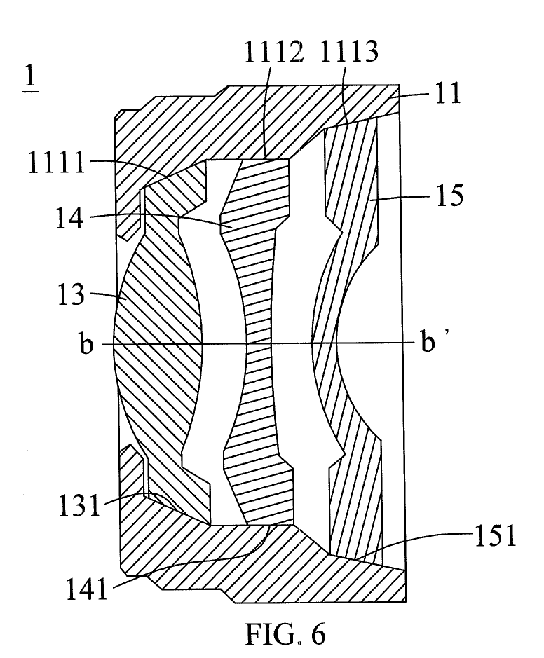

FIGS. 4 to 6 are schematic views of a lens structure in accordance with a second embodiment of the present invention. Referring to FIGS. 4 to 6, a lens structure 1 includes a lens barrel 11 shaped like a barrel and having an inner wall 11 not parallel with a central axis aa′, a first lens 13 having a first engaging side 131 apart from an optical axis bb′, wherein the first engaging side 131 corresponds to the inner wall 111, such that the first engaging side 131 of the first lens 13 is engaged with the inner wall 111 and in the lens barrel 11, and a second lens 14 having a second engaging side 141 apart from the optical axis bb′, wherein the second engaging side 141 corresponds to the inner wall 111, such that the second engaging side 141 of the second lens 14 is engaged with the inner wall 111 and in the lens barrel 11.

In an embodiment, when the inner wall 111, due to wearing, is separate from the first or second engaging side 131 or 141, the first or second lens 13 or 14 has a shift along the optical axis bb′ such that the first or second engaging side 131 or 141 is engaged with the inner wall 111 again.

In an embodiment, an angle between the inner wall 111 and a radial direction of the lens barrel 11, an angle between the first engaging side 131 and the radial direction and an angle between the second engaging side 141 and the radial direction are between 45 and 80 degrees.

In an embodiment, the inner wall 111 has a first engaging surface 1111 and a second engaging surface 1112, wherein an angle between the first engaging surface 1111 and the radial direction of the lens barrel 11 is different from that between the second engaging surface 1112 and the radial direction of the lens barrel 11, wherein the first engaging side 131 is engaged with the first engaging surface 1111, and the second engaging side 141 is engaged with the second engaging surface 1112.

In accordance with the present invention, the first lens 13 has the first engaging side 131 engaged with the first engaging surface 1111 and is led to be engaged in the lens barrel 11. The second lens 14 has the second engaging side 141 engaged with the second engaging surface 1112 and is led to be engaged in the lens barrel 11. Thereby, the first and second lenses 13 and 14 are individually engaged in the lens barrel 11.

In an embodiment, the lens structure further includes a third lens 15 having a third engaging side 151 apart from the optical axis bb′, wherein the third engaging side 151 corresponds to the inner wall 111, such that the third engaging side 151 of the third lens 15 is engaged with the third engaging surface 1113 and in the lens barrel 11, individually.

Besides, the inner wall 111 can be a continuous or discontinuous inclined surface.

When the inner wall 111 is a continuous inclined surface, both an angle between the first engaging surface 1111 and the radial direction of the lens barrel 11 and an angle between the first engaging side 131 and the radial direction of the lens barrel 11 can be the same angle θ₃, both an angle between the second engaging surface 1112 and the radial direction of the lens barrel 11 and an angle between the second engaging side 141 and the radial direction of the lens barrel 11 can be the same angle θ₄, and both an angle between the third engaging surface 1113 and the radial direction of the lens barrel 11 and an angle between the third engaging side 151 and the radial direction of the lens barrel 11 can be the same angle θ₅, wherein the angles θ₃, θ₄ and θ₅ can be the same. The first, second and third lenses 13, 14 and 15 each have a surface apart from an end of the lens barrel 11 by distances H₁, H₂ and H₃, respectively. The first lens 13 is apart from the second lens 13 by a distance H₄, and the second lens 14 is apart from the third lens 15 by a distance H₅.

When the inner wall 111 is a discontinuous inclined surface, both an angle between the first engaging surface 1111 and the radial direction of the lens barrel 11 and an angle between the first engaging side 131 and the radial direction of the lens barrel 11 can be an angle θ₃, both an angle between the second engaging surface 1112 and the radial direction of the lens barrel 11 and an angle between the second engaging side 141 and the radial direction of the lens barrel 11 can be an angle θ₄, and both an angle between the third engaging surface 1113 and the radial direction of the lens barrel 11 and an angle between the third engaging side 151 and the radial direction of the lens barrel 11 can be an angle θ₅, wherein the angles θ₃, θ₄ and θ₅ can be different from one another.

Thereby, in accordance with the lens structure 1 of the present invention, the angles θ₃, θ₄ and θ₅ and the distances H₁, H₂, H₃, H₄ and H₅ can be changed to achieve various imaging effects. The angles θ₃, θ₄ and θ₅ and the distances H₁, H₂, H₃, H₄ and H₅ can be arranged in different combinations, such as θ₃≠θ₄=θ₅, θ₃=θ₄=θ₅, H₁≠H₂≠H₃ or H₁=H₄≠H₅.

Besides, the first, second or third engaging surface 1111, 1112 or 1113 can be designed to be parallel with the central axis aa′.

By the way, the above arrangement is an embodiment and should not be limited to the present invention.

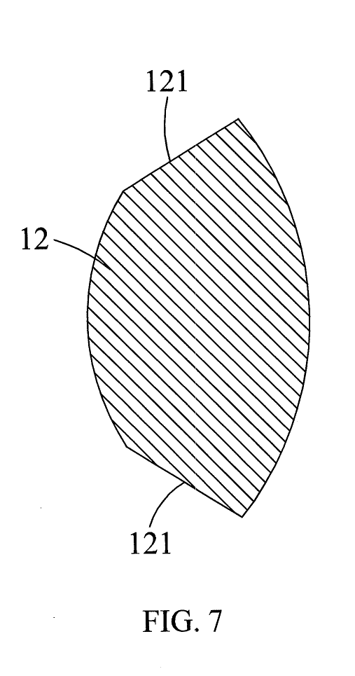

FIG. 7 is a schematic view of a lens of a lens structure in accordance with the present invention. Referring to FIGS. 1-7, the lens 12 of the lens structure 1 may have the engaging side 121 designed as inclined surfaces, and the first, second and third lenses 13, 14 and 15 may be individually engaged in the lens barrel 11 and may not be engaged with one another.

Thereby, the lens 12 has a simplified structure and can be easily processed and polished. Particularly, the lens 12 can be made of glass.

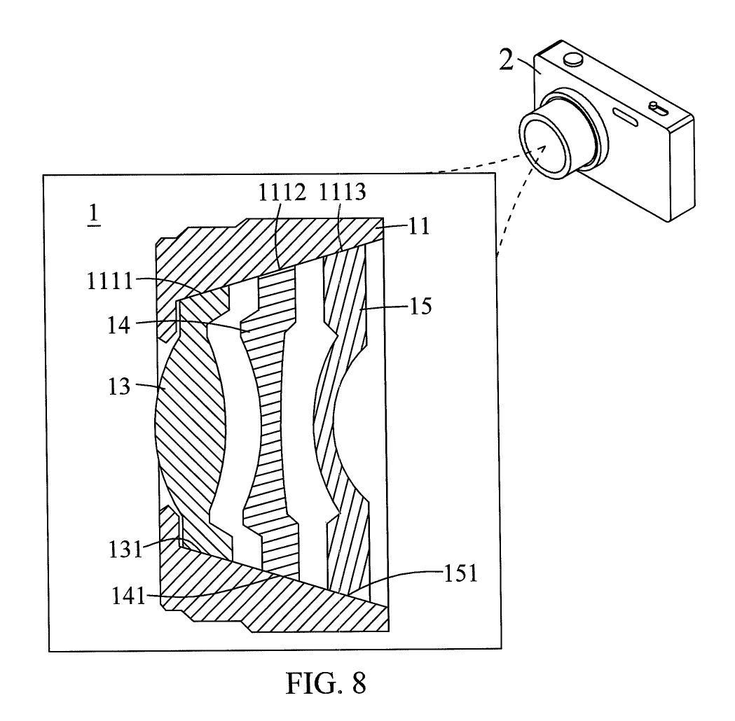

FIG. 8 is a schematic view of an image capturing device in accordance with the present invention. Referring to FIG. 8, an image capturing device 2 encompasses the lens structure 1 and a lens pedestal, wherein the lens structure 1 includes the lens barrel 11 and the first, second and third lenses 13, 14 and 15, as mentioned above and not described herein.

In accordance with the present invention, the lens structure 1 can be applied to various image capturing devices, such as digital cameras or mobile phones. Using the lens structure of the present invention, the digital cameras or mobile phones can avoid the problem that the lenses are loose or out of center. Furthermore, glass can be used to form the lenses.

To sum up, in accordance with the present invention, the lens structure and the image capturing device thereof are designed with the inner wall of the lens barrel and the sides of the lenses, and thus loose, squeeze or interference created due to the errors in assembly of the prior art can be solved. Resolution can be prevented from being lowered. Furthermore, glass can be used to form the lenses.

In accordance with the present invention, the lens structure and the image capturing device thereof are designed with the inner wall of the lens barrel and the sides of the lenses, and thus the problem that the lenses become loose and out of center can be avoided when the inner wall of the lens barrel wears.

What is claimed is:

1. A lens structure comprising:
a lens barrel being a barrel-like shape structure and having an inner wall not parallel with a central axis; and
a lens having an engaging side apart from an optical axis;
wherein the engaging side corresponds to the inner wall, and the engaging side of the lens is engaged with the inner wall and in the lens barrel.

2. The lens structure of claim 1, wherein the lens has a shift along the optical axis when the inner wall is worn, and the engaging side is engaged with the inner wall again due to the shift.

3. The lens structure of claim 1, wherein an angle between the inner wall and a radial direction of the lens barrel, and an angle between the engaging side and the radial direction are between 45 and 80 degrees.

4. The lens structure of claim 1, wherein the inner wall has a first engaging surface and a second engaging surface, and an angle between the first engaging surface and the radial direction of the lens barrel is different from that between the second engaging surface and the radial direction of the lens barrel.

5. A lens structure comprising:
a lens barrel being a barrel-like shape structure and having an inner wall not parallel with a central axis;
a first lens having a first engaging side apart from an optical axis, wherein the first engaging side corresponds to the inner wall, and the first engaging side of the first lens is engaged with the inner wall and in the lens barrel; and
a second lens having a second engaging side apart from the optical axis, wherein the second engaging side corresponds to the inner wall, and the second engaging side of the second lens is engaged with the inner wall and in the lens barrel.

6. The lens structure of claim 5, wherein the first or second lens has a shift along the optical axis when the inner wall is worn, and the first or second engaging side is engaged with the inner wall again due to the shift.

7. The lens structure of claim 5, wherein an angle between the inner wall and a radial direction of the lens barrel, an angle between the first engaging side and the radial direction, and an angle between the second engaging side and the radial direction are between 45 and 80 degrees.

8. The lens structure of claim 5, wherein the inner wall has a first engaging surface and a second engaging surface, and an angle between the first engaging surface and the radial direction of the lens barrel is different from that between the second engaging surface and the radial direction of the lens barrel, and the first engaging side is engaged with the first engaging surface, and the second engaging side is engaged with the second engaging surface.

9. An image capturing device comprising a lens structure and a lens pedestal, wherein the lens structure comprises:
a lens barrel being a barrel-like shape structure and having an inner wall not parallel with a central axis;
a first lens having a first engaging side apart from an optical axis, wherein the first engaging side corresponds to the inner wall, and the first engaging side of the first lens is engaged with the inner wall and in the lens barrel; and
a second lens having a second engaging side apart from the optical axis, wherein the second engaging side corresponds to the inner wall, and the second engaging side of the second lens is engaged with the inner wall and in the lens barrel.

10. The image capturing device of claim 9, wherein the first or second lens has a shift along the optical axis when the inner wall is worn, and the first or second engaging side is engaged with the inner wall again due to the shift.

11. The image capturing device of claim 9, wherein an angle between the inner wall and a radial direction of the lens barrel, an angle between the first engaging side and the radial direction, and an angle between the second engaging side and the radial direction are between 45 and 80 degrees.

12. The image capturing device of claim 9, wherein the inner wall has a first engaging surface and a second engaging surface, wherein an angle between the first engaging surface and the radial direction of the lens barrel is different from that between the second engaging surface and the radial direction of the lens barrel, wherein the first engaging side is engaged with the first engaging surface, and the second engaging side is engaged with the second engaging surface.
